(19) United States
(12) Patent Application Publication
(10) Pub. No.: US 2010/0146153 A1
(43) Pub. Date: Jun. 10, 2010

(54) FUNCTION MODULE INTEGRATING DEVICE

(75) Inventors: YIH-CHENG CHEN, Sindian City (TW); Chung-Kwang Chen, Taipei (TW)

Correspondence Address: Wang Law Firm, Inc., 4989 Peachtree Parkway,, Suite 200, Norcross, GA, 30092, US

(73) Assignee: CC&C Technologies,Inc, Jhonghe City (TW)

(21) Appl. No.: 12/543,471

(22) Filed: Aug. 18, 2009

(30) Foreign Application Priority Data
Dec. 4, 2008 (TW) 097221742
Jun. 10, 2009 (TW) 098210346

(51) Int. Cl. G06F 3/00; G06F 15/173

(52) U.S. Cl. 710/8; 709/223

(57) ABSTRACT

A function module integrating device is disposed on an upper frame of a display of an electronic apparatus to communicate with a peripheral communication module on a motherboard of the electronic apparatus. In an embodiment, the function module integrating device comprises plural function modules and a connector. The function modules comprise a long-distance wireless communication module, a short-distance wireless communication module, and a video module. The connector is connected to each function modules and also electrically connected to the peripheral communication module on the motherboard of the electronic apparatus. In another embodiment, the function module integrating device is wirelessly connected to the electronic apparatus via wireless communication of a module-end wireless communication module of the device with an apparatus-end wireless communication module of the electronic apparatus. In another embodiment, the function module integrating device is electrically connected via the USB hub module to a motherboard of the electronic apparatus.

### FIELD OF THE INVENTION

The present invention relates to a function module integrating device, and more particularly to a function module integrating device using the same pins for externally connected devices.

### BACKGROUND OF THE INVENTION

With the highly developed electronic technologies, various kinds of electronic products applying new techniques are constantly introduced into the market. As a result, many previously purchased electronic products may no longer fulfill the users' demands. However, since the universal serial bus (USB), which provides the advantages of simple structure, high transmission efficiency, plug and play, and matured technique, has already been widely employed as a connection interface between computers and various kinds of 3C electronic products and other related expansion modules. The users may now purchase peripherals with USB transmission interface to expand the functions of the previously purchased electronic products all by themselves.

Currently, the USB ports are usually provided on the desktop computer at front or rear side thereof, or on the notebook computer at two lateral sides thereof. Therefore, the connection of different peripherals to the computer is limited to the positions with the USB ports. The user has to use a relatively long conductor (cable) to distantly connect the peripherals to the computer. This will no doubt cause inconvenience to the use in operating the peripherals. With the increasing of peripheral numbers, a large space is occupied by these peripherals and the cables thereof tend to disorderly scatter on a desk or tangle with one another to adversely affect the aesthetic appearance of the computer.

To solve the above problems, many computers and 3C electronic products with multiple built-in functions have been developed to save the users from the trouble of carrying different peripherals for use outdoors. However, once manufactured, the computers and the various kinds of 3C electronic products, either with built-in or externally connected peripherals, are usually provided with fixed number of USB ports. This is, the computers or the electronic products may not be functionally expanded by internally building or externally connecting to more electronic peripherals at the same time, resulting in many inconveniences in practical use of the computers or the electronic products.

### SUMMARY OF THE INVENTION

A primary object of the present invention is to provide a function module integrating device to overcome the problem that only very limited number of electronic peripherals may be built in the conventional electronic products.

To achieve the above and other objects, the function module integrating device according to a first embodiment of the present invention is disposed on an upper frame of a display of an electronic apparatus that has a motherboard provided with a peripheral communication module. The function module integrating device comprises a plurality of function modules and a connector. The plurality of function modules comprises a long-distance wireless communication module, a short-distance wireless communication module and a video module. A long-distance wireless communication function is provided by the long-distance wireless communication module, a short-distance wireless communication function is provided by the short-distance wireless communication module, and a network video function is provided by the video module. The connector is connected to the plurality of function modules, and is also electrically connected to the peripheral communication module on the motherboard of the electronic apparatus.

The function module integrating device according to a second embodiment of the present invention is disposed on an upper frame of a display of an electronic apparatus that is internally provided with an apparatus-end wireless communication module. The function module integrating device comprises a plurality of function modules and a module-end wireless communication module. The plurality of function modules comprises a long-distance wireless communication module, a short-distance wireless communication module and a video module. A long-distance wireless network function is provided by the long-distance wireless communication module provides, a short-distance wireless communication function is provided by the short-distance wireless communication module, and a network video function is provided by the video module. The module-end wireless communication module is connected to the plurality of function modules, and is also wirelessly electrically connected to the apparatus-end wireless communication module in the electronic apparatus.

The function module integrating device according to a third embodiment of the present invention is disposed on an upper frame of a display of an electronic apparatus. The function module integrating device comprises a plurality of function modules and a USB hub module. The plurality of function modules comprises a long-distance wireless communication module, a short-distance wireless communication module and a video module. A long-distance wireless network function is provided by the long-distance wireless communication module provides, a short-distance wireless communication function is provided by the short-distance wireless communication module, and a network video function is provided by the video module. The USB hub module further comprises a control module for controlling the plurality of function modules and connecting to a motherboard of the electronic apparatus.

The electronic apparatus is preferably a notebook computer, a desktop computer, a personal digital assistant (PDA), a mobile phone, an MP3 player, a liquid crystal display (LCD) monitor or the like.

Preferably, the long-distance wireless communication module is selected from the group consisting of a Wi-Fi module, a Worldwide Interoperability for Microwave Access (WiMAX) module, a High Speed Downlink Packet Access (HSDPA) communication module, a High Speed Uplink Packet Access (HSUPA) communication module, and other functionally equivalent wireless communication modules.

Preferably, the short-distance wireless communication module is selected from the group consisting of a Bluetooth communication module, an infrared (IR) communication module, a ZigBee module, an ultra wideband (UWB) module, and other functionally equivalent wireless communication modules.

Preferably, the function module integrating device of the present invention further comprises a module selected from the group consisting of a microphone pickup module, a global positioning system (GPS), and other expansion function modules connected to the connector, the module-end wireless communication module, or the USB hub module. And, according to actual need, one or more modules may be simultaneously connected to the electronic apparatus to further expand the functions thereof.

To allow a user to conveniently use the network video function, the video module of the function module integrating device is particularly disposed at a middle point of the upper frame of the display. With the function module integrating device disposed on the upper frame of the display, both of the long-distance wireless communication module and the short-distance wireless communication module may have better signal receiving and transmitting quality.

With the above arrangements, the function module integrating device of the present invention provides one or more of the following advantages:

(1) Since a plurality of chip modules are integrated into one device, it is not necessary to prepare several different peripheral devices at the same time, making the electronic apparatus more convenient for use; and

(2) With the function module integrating device disposed on the upper frame of the display of the electronic apparatus, the user may more conveniently use the video function and signals may be wirelessly received and transmitted in better quality.

### BRIEF DESCRIPTION OF THE DRAWINGS

The structure and the technical means adopted by the present invention to achieve the above and other objects may be best understood by referring to the following detailed description of the preferred embodiments and the accompanying drawings, wherein

FIG. 1 is a block diagram of a function module integrating device according to a first embodiment of the present invention;

FIG. 2 is a block diagram of a function module integrating device according to a second embodiment of the present invention;

FIG. 3 is a block diagram of a function module integrating device according to a third embodiment of the present invention; and

FIG. 4 shows an exemplary position on a notebook computer for disposing the function module integrating device of the present invention.

### DETAILED DESCRIPTION OF THE PREFERRED EMBODIMENTS

The present invention will now be described with some preferred embodiments thereof For the purpose of easy to understand, elements that are the same in the preferred embodiments are denoted by the same reference numerals.

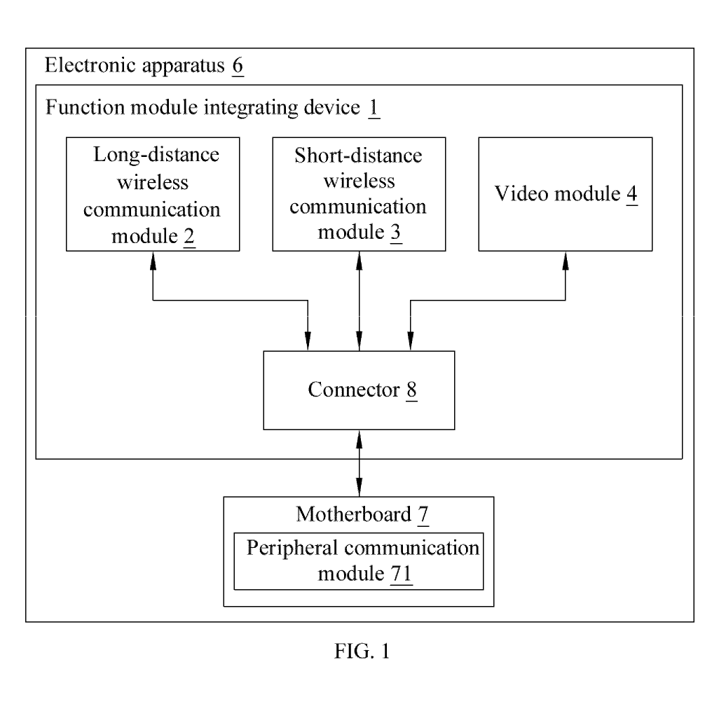

Please refer to FIG. 1 that is a block diagram of a function module integrating device 1 according to a first embodiment of the present invention. The function module integrating device 1 in the first embodiment comprises a plurality of function modules and a connector 8. The plurality of function modules may be selected from the group consisting of a long-distance wireless communication module 2, a short-distance wireless communication module 3 and a video module 4. A long-distance wireless network function is provided by the long-distance wireless communication module 2, a short-distance wireless communication function is provided by the short-distance wireless communication module 3, and a network video function is provided by the video module 4. The function module integrating device 1 may be built in an electronic apparatus 6 and directly connected via the connector 8 to a peripheral communication module 71 on a motherboard 7 of the electronic apparatus 6. The peripheral communication module 71 may be a universal serial bus (USB) pin or other pins for peripheral communication.

The long-distance wireless communication module 2 may be selected from the group consisting of a Wi-Fi module, a Worldwide Interoperability for Microwave Access (WiMAX) module, a High Speed Downlink Packet Access (HSDPA) communication module, a High Speed Uplink Packet Access (HSUPA) communication module, and other functionally equivalent wireless communication modules. That is, the long-distance wireless communication module 2 may be any one or any combination of the above mentioned wireless communication modules. The long-distance wireless communication module 2 may provide a user with the wireless Internet access service. That is, a user at any place may link to the Internet to access different network communication functions, including but not limited to Internet Relay Chat (IRC), online games, data search, resource download/sharing, receiving and sending emails, etc.

The short-distance wireless communication module 3 may be selected from the group consisting of a Bluetooth communication module, an infrared (IR) communication module, a ZigBee module, an ultra wideband (UWB) module, and other functionally equivalent wireless communication modules. That is, the short-distance wireless communication module 3 may be any one or any combination of the above wireless communication modules. The short-distance wireless communication module 3 enables wireless signal transmission to and from any headphone, mouse and microphone equipped with the short-distance wireless communication function. Unlike the long-distance wireless communication module 2, the short-distance wireless communication module 3 mainly provides wireless signal transmission within a relatively short distance. However, the signal transmitted via the short-distance wireless communication module 3 has relatively higher security. The short-distance wireless communication is not easily subjected to environmental interferences and has the advantage of low power consumption to save electric energy. The video module 4 provides various network video functions, such as conducting video conference, surveillance image recording, audio/video chat, etc.

In addition, the module integrating device 1 may further comprise a microphone pickup module, a global positioning system (GPS) module, or other expansion function modules, so as to enhance the functionality of computers or various kinds of 3C electronic products. According to actual demand, one or more modules may be simultaneously connected to the electronic apparatus to further expand the functions or applications thereof

The USB hub module 5 is connected to the long-distance wireless communication module 2, short-distance wireless communication module 3 and the video module 4 to make the function module integrating device use the same pins for externally connected devices.

In the illustrated first embodiment of the present invention, since the function module integrating device 1 has integrated three function modules, namely, the long-distance wireless communication module 2, the short-distance wireless communication module 3 and the video module 4. Electronic products built-in the function module integrating device 1 may have the functions of long-distance wireless, short-distance wireless and video communication. It is not necessary for a user owning the electronic products to carry about other wireless network card, Bluetooth transceiver module or video camera.

The connector 8 is directly electrically connected to the peripheral communication module 71 on the motherboard 7 of the electronic apparatus 6. Since the function module integrating device 1 is internally built in the electronic apparatus 6, any transmission cables of the function module integrating device 1 may be organized and received inside the electronic apparatus 6 to effectively solve the problem of disordered and tangled cables externally connected to the electronic apparatus 6, giving the electronic apparatus 6 an aesthetic appearance.

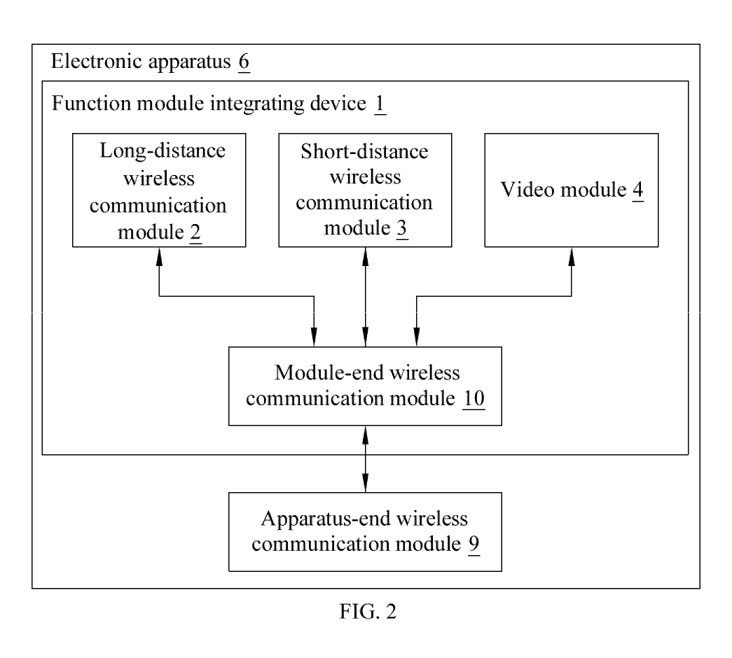

The function module integrating device 1 of the present invention may be connected to the electronic apparatus 6 either via physical cables or wireless communication to enable data transmission and data exchange. Please refer to FIG. 2, which is a block diagram of the function module integrating device 1 according to a second embodiment of the present invention. The function module integrating device 1 in the second embodiment is built in the electronic apparatus 6 and is wirelessly electrically connected via a module-end wireless communication module 10 in the function module integrating device 1 to an apparatus-end wireless communication module 9 in the electronic apparatus 6.

The module-end wireless communication module 10 may be a Bluetooth module, an IR communication module, a ZigBee module, a UWB module, a Wi-Fi module, a WiMAX module, a HSDPA module, a HSUPA module, or other functionally equivalent wireless communication modules.

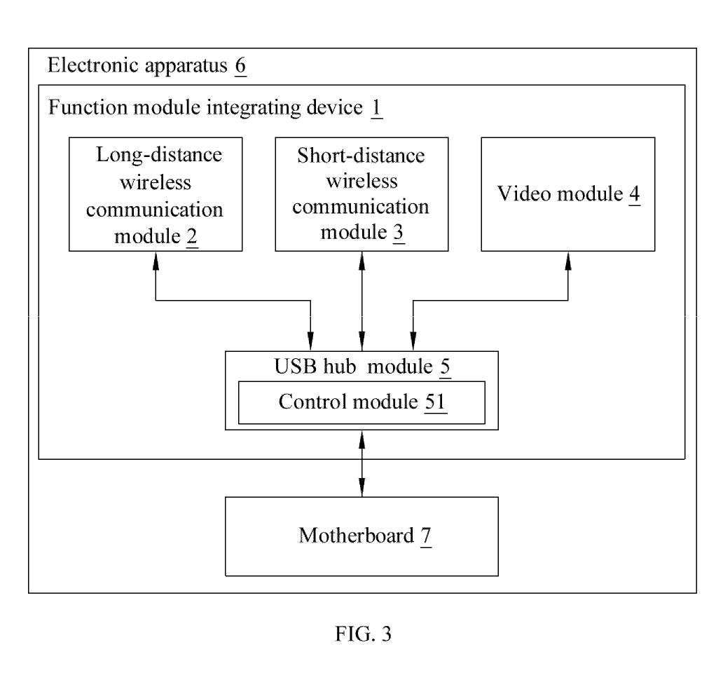

Please refer to FIG. 3 that is a block diagram of a function module integrating device 1 according to a third embodiment of the present invention. The function module integrating device 1 is built in an electric apparatus 6 and is connected to a motherboard 7 of the electric apparatus 6 via the USB hub module 5. The USB hub module 5 further comprises a control module 51 for controlling the long-distance wireless communication module 2, short-distance wireless communication module 3 and video module 4.

The USB ports number in the motherboard of the electric apparatus is limited. The long-distance wireless communication module 2, short-distance wireless communication module 3 and video module 4 are integrated in the function module integrating device, so that only a USB port in the motherboard is used for the function module integrating device. Then the spared USB ports of the motherboard may be used for other peripherals with USB interface.

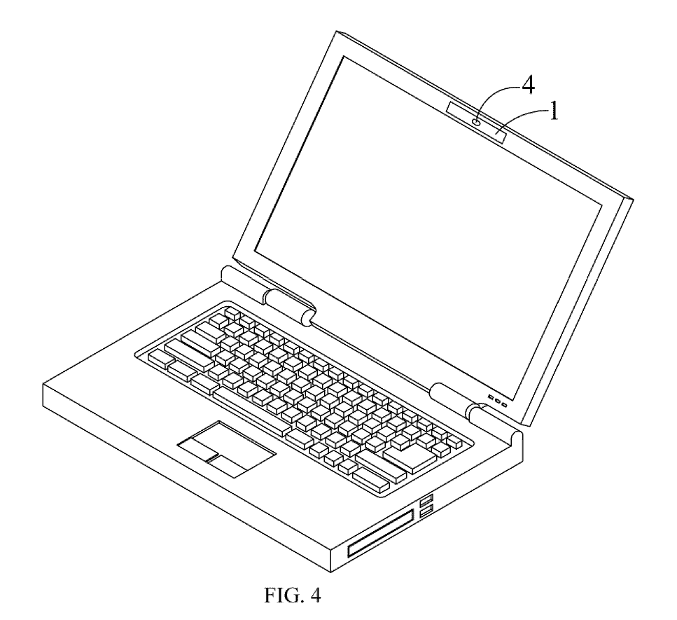

FIG. 4 shows an exemplary position on an electronic apparatus for disposing the function module integrating device 1 of the present invention. In the illustration example, the electronic apparatus is a notebook computer, and the function module integrating device 1 is disposed on a middle point of the upper frame of a display of the notebook computer, allowing a user to conveniently use the video function. With the function module integrating device 1 disposed on a relatively high position of the notebook computer, both of the long-distance wireless communication module 2 and the short-distance wireless communication module 3 may have better signal receiving and transmitting quality. However, the function module integrating device 1 may be otherwise disposed at any position that allows a user to use the video function conveniently. Since the function module integrating device 1 is built in the notebook computer, the user does not need to troublesomely carry about other external expansion modules for outdoors using. Spaces that are otherwise occupied by externally connected devices may be reduced to give the whole computer an orderly and aesthetic appearance. While the electronic apparatus illustrated in FIG. 3 is a notebook computer, the function module integrating device 1 may also be disposed on other related electronic apparatuses, such as a desktop computer, a personal digital assistant (PDA), a mobile phone, a MP3 player, a liquid crystal display (LCD) monitor or the like.

The present invention has been described with some preferred embodiments thereof and it is understood that many changes and modifications in the described embodiments may be carried out without departing from the scope and the spirit of the invention that is intended to be limited only by the appended claims.

What is claimed is:

1. A function module integrating device disposed on an upper frame of a display of an electronic apparatus that has a motherboard provided with a peripheral communication module, comprising:
a plurality of function modules selected from the group consisting of a long-distance wireless communication module, a short-distance wireless communication module and a video module, and a long-distance wireless communication function is provided by the long-distance wireless communication module, a short-distance wireless communication function is provided by the short-distance wireless communication module and a network video function is provided by the video module; and
a connector being connected to the plurality of function modules and also being electrically connected to the peripheral communication module of the electronic apparatus.

2. The function module integrating device as claimed in claim 1, wherein the electronic apparatus is a notebook computer, a desktop computer, a PDA, a mobile phone, a MP3 player, or a LCD monitor.

3. The function module integrating device as claimed in claim 1, wherein the long-distance wireless communication module is selected from the group consisting of a Wi-Fi module, a Worldwide Interoperability for Microwave Access (WiMAX) module, a High Speed Downlink Packet Access (HSDPA) communication module, a High Speed Uplink Packet Access (HSUPA) communication module, and any combination thereof.

4. The function module integrating device as claimed in claim 1, wherein the short-distance wireless communication module is selected from the group consisting of a Bluetooth communication module, an infrared (IR) communication module, a ZigBee module, an ultra wideband (UWB) module, and any combination thereof

5. The function module integrating device as claimed in claim 1, further comprising a module selected from the group consisting of a microphone pickup module, a GPS module, and any combination thereof, and the module is connected to the connector.

6. A function module integrating device disposed on an upper frame of a display of an electronic apparatus that is internally provided with an apparatus-end wireless communication module, comprising:
a plurality of function modules selected from the group consisting of a long-distance wireless communication module, a short-distance wireless communication module, a video module, and a long-distance wireless communication function is provided by the long-distance wireless communication module, a short-distance wireless communication function is provided by the short-distance wireless communication module, and a network video function is provided by the video module; and
a module-end wireless communication module being connected to the plurality of function modules and also being wirelessly electrically connected to the apparatus-end wireless communication module.

7. The function module integrating device as claimed in claim 6, wherein the module-end wireless communication module is selected from the group consisting of a Bluetooth module, an IR communication module, a ZigBee module, a UWB module, a Wi-Fi module, a WiMAX module, a HSDPA module, and a HSUPA module.

8. The function module integrating device as claimed in claim 6, wherein the electronic apparatus is a notebook computer, a desktop computer, a PDA, a mobile phone, a MP3 player, or a LCD monitor.

9. The function module integrating device as claimed in claim 6, wherein the long-distance wireless communication module is selected from the group consisting of a Wi-Fi module, a WiMAX module, a HSDPA communication module, a HSUPA communication module, and any combination thereof.

10. The function module integrating device as claimed in claim 6, wherein the short-distance wireless communication module is selected from the group consisting of a Bluetooth communication module, an IR communication module, a ZigBee module, a UWB module, and any combination thereof.

11. The function module integrating device as claimed in claim 6, further comprising a module selected from the group consisting of a microphone pickup module, a GPS module, and any combination thereof, and the module is connected to the module-end wireless communication module.

12. A function module integrating device disposed on an upper frame of a display of an electronic apparatus, comprising:
a plurality of function modules selected from the group consisting of a long-distance wireless communication module, a short-distance wireless communication module and a video module, and a long-distance wireless communication function is provided by the long-distance wireless communication module, a short-distance wireless communication function is provided by the short-distance wireless communication module and a network video function is provided by the video module ; and
a universal serial bus (USB) hub module being connected to the plurality of function modules.

13. The function module integrating device as claimed in claim 12, wherein the function module integrating device is electrically connected via the USB hub module to a motherboard of the electronic apparatus.

14. The function module integrating device as claimed in claim 12, wherein the USB hub module further comprises a control module for controlling the plurality of function modules.

15. The function module integrating device as claimed in claim 12, wherein the electronic apparatus is a notebook computer, a desktop computer, a PDA, a mobile phone, a MP3 player, or a LCD monitor.

16. The function module integrating device as claimed in claim 12, wherein the long-distance wireless communication module is selected from the group consisting of a Wi-Fi module, a WiMAX module, a HSDPA communication module, a HSUPA communication module, and any combination thereof.

17. The function module integrating device as claimed in claim 12, wherein the short-distance wireless communication module is selected from the group consisting of a Bluetooth communication module, an IR communication module, a ZigBee module, a UWB module, and any combination thereof.

18. The function module integrating device as claimed in claim 12, further comprising a module selected from the group consisting of a microphone pickup module, a GPS module, and any combination thereof, and the module is connected to the USB hub module.
